(19) United States
(12) Patent Application Publication
(10) Pub. No.: US 2026/0100833 A1
(43) Pub. Date: Apr. 9, 2026

(54) PRIVACY PRESERVING CREDENTIAL TOKEN ISSUANCE

(71) Applicant: International Business Machines Corporation, Armonk, NY (US)

(72) Inventors: Alessandro Sorniotti, Zurich (CH); Elli Androulaki, Zurich (CH); Kaoutar El Khiyaoui, Zurich (CH); Yacov Manevich, Munich (DE); Jens Jelitto, Rueschlikon (CH); Ilie Circiumaru, Zurich (CH); Pasquale Convertini, Adliswil (CH)

(21) Appl. No.: 18/906,336

(22) Filed: Oct. 4, 2024

(51) Int. Cl. H04L 9/30

(52) U.S. Cl. CPC H04L 9/30

(57) ABSTRACT

Mechanisms are provided for re-issuance of credentials in a data network. The mechanisms receive, from a requester entity, a first request to re-issue a target credential in a plurality of credentials of a public credential listing. Any entity, in a plurality of entities, can request re-issuance of any credential in the plurality of credentials and have the credential successfully re-issued to that entity. The mechanisms, in response to the request to re-issue the target credential, re-randomize an original public key associated with the target credential to generate a re-randomized public key. The mechanisms generate a new credential based on the target credential but with the original public key replaced with the re-randomized public key. The mechanisms provide the new credential to the requester entity. The requester entity can use the new credential for authentication successfully only if the requester entity is an owner of the target credential.

### BACKGROUND

The present application relates generally to an improved data processing apparatus and method and more specifically to an improved computing tool and improved computing tool operations/functionality for performing privacy preserving credential token issuance.

A JavaScript Object Notation (JSON) Web Token (JWT) is a JSON object used to securely transfer information over the Internet, or web, between parties. A JWT is composed of a header, payload, and signature. The payload may hold encrypted data having one or more claims. The JWT claims can be used to pass the identity of authenticated users between an identity provider and a service provider, or any other type of claims as required by business processes. The JWT is signed using a private secret or public/private key.

For example, a server may generate a JWT that has the claim “logged in as administrator” and provide the JWT to a client. The client may then use the JWT to prove that it is logged in as an administrator. The JWTs can be signed by one party's private key, e.g., the server's private key, so that any party can subsequently verify whether the token is legitimate. If the other party, by some suitable and trustworthy means, is in possession of the corresponding public key, they too are able to verify the JWT's legitimacy.

Self-Sovereign Identity (SSI) is an approach to digital identity that gives individuals control over the information they use to prove who they are to websites, services, and applications across the web. Without SSI, individuals with persistent accounts (identities) across the Internet must rely on a number of large identity providers that have control of the information associated with their identity. If a user chooses not to use a large identity provider, then they have to create new accounts with each service provider, which fragments their web experiences. SSI offers a way to avoid these undesirable alternatives by providing a mechanism through which a user accesses services in a streamlined and secure manner while maintaining control over the information associated with their identity.

SSI addresses the difficulty of establishing trust in an interaction. In order to be trusted, one party in an interaction will present credentials to the other parties, and those relying on the parties can verify that the credentials came from an issuer that they trust. In this way, the verifier's trust in the issuer is transferred to the credential holder. This basic structure of SSI, with three participants, is sometimes called “the trust triangle”.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for re-issuance of credentials in a data network. The method comprises receiving, from a requester entity, a first request to re-issue a target credential in a plurality of credentials of a public credential listing. Any entity, in a plurality of entities, can request re-issuance of any credential in the plurality of credentials and have the credential successfully re-issued to that entity. The method further comprises, in response to the request to re-issue the target credential, re-randomizing an original public key associated with the target credential to generate a re-randomized public key. The method also comprises generating a new credential based on the target credential but with the original public key replaced with the re-randomized public key. In addition, the method comprises providing the new credential to the requester entity, wherein the requester entity can use the new credential for authentication transactions successfully only if the requester entity is an owner of the target credential.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example of a JSON web token (JWT) type token;

FIG. 2 is an example diagram illustrating a trust triangle relationship between issuer, holder, and verifier;

FIG. 3 is an example diagram illustrating a verifiable credential issued by an issuer in the trust triangle in accordance with JWT and Self-Sovereign Identity (SSI) protocol;

FIG. 4 is an example diagram illustrating a JWT token shown by the holder to the verifier in accordance with JWT and SSI protocol;

FIG. 5 is an example diagram illustrating the interaction between the issuer, a user, and a verifier in accordance with the issuance and reissuance mechanisms of the illustrative embodiments;

FIG. 6 is an example diagram of a distributed data processing system environment in which aspects of the illustrative embodiments may be implemented and at least some of the computer code involved in performing the inventive methods may be executed;

FIG. 7 is an example block diagram illustrating the primary operational components of a credential issuance and reissuance (CIRI) engine in accordance with one illustrative embodiment; and

FIG. 8 is a flowchart outlining an example operation for re-issuing credentials in accordance with one illustrative embodiment.

### DETAILED DESCRIPTION

The illustrative embodiments provide an improved computing tool and improved computing tool operations/functionality for performing privacy preserving token issuance. Data security is of the upmost importance as life is increasingly dependent on computers and data networks. It is unfortunately the case that large scale breaches of data security with regard to organizations' computing systems and data storage, as well as individual's personal information, are increasingly being reported more frequently. This has led to governments and organizations instituting laws and policies to require security mechanisms to be implemented, such as Self-Sovereign Identity (SSI), JavaScript Object Notation (JSON) Web Token (JWT), and the like. However, while these technologies may provide some improvements to data security, they still have issues that need to be resolved so as to avoid exploitation by back actors. In Europe, for example, nation states are implementing SSI schemes but are torn between two implementation options: “option A” involves using simple, standard-compatible cryptography which does not provide enhanced privacy, e.g., using SSI with token (e.g., JSON web token (JWT)) based authentication mechanisms; and “option B” involves enhanced schemes that provide good standards of privacy but cannot be rolled out immediate because of the lack of standard software and/or hardware (e.g., BBS+ and the like). Neither option provides an optimal solution to the problems of data security and deanonymization of individuals.

The illustrative embodiments provide an improved computing tool and improved computing tool operations/functionality that is specifically directed to providing a third option, i.e., an “option C”, where both enhanced privacy and compatibility with standardized cryptographic mechanisms is achieved. The illustrative embodiments implement computing tool mechanisms that change the way that token issuance and re-issuance is performed, but leaves presentation and verification of the credentials identical and fully compatible with standards, such as JWT/OpenID standards, or the like. The illustrative embodiments split the issuance of credentials into two primary operations, i.e., initial issuance and re-issuance. Initial issuance takes place with a set of attributes and a public key being certified (signed) in a credential by an issuer. The issuer publishes all certified public keys and credentials.

Upon re-issuance, any holder in the overall system can ask for the re-issuance of any credential, whether their own or those associated with other holders. Reissuance is always successful and equips the requester with a signature over the same set of certified attributes for the chosen credential that is reissued, and for a re-randomization of the associated public key. Only the holder of the credential can actually make use of the obtained re-issued credential, however that fact is not known to anyone in the system, thereby creating the possibility of having decoy requests and “hiding” in the multitude of requests, e.g., hiding the actual holder of the public key in plain sight within the larger population since anyone in the population can successfully request re-issuance, not just the holder. This makes it difficult to correlate usage of public keys so as to build profiles of individuals within the larger population. As an example, one could ask for the re-issuance of all credentials in the system and then transact with that individual's re-issued credential, thus hiding perfectly in the anonymity set created by other users in the system with the same attributes, e.g., if the attribute only certified the person's gender, than that person would hide in the population with the same gender.

Re-issuance is a blind protocol when it comes to the issuer. In the cryptographic sense, the issuer only knows which original credential (and associated public key) is the basis of the re-issuance. The issuer does not know the new, re-randomized public key that will be associated with the re-issued credential and does not know whether the owner or someone else requested the re-issuance. In this way, users can ask for decoy reissuance requests and achieve the same level of privacy that they would be provided had they used more difficult to roll out advance protocols, such as BBS+ or the like. Thus, the illustrative embodiments provide an improved computing tool and improved computing tool operations/functionality specifically directed to solving the problems in existing solutions for data security and privacy of individuals, especially with regard to compatibility with standards while providing enhanced data security.

The following description provides examples of embodiments of the present disclosure, and variations and substitutions may be made in other embodiments. Several examples will now be provided to further clarify various aspects of the present disclosure.

Example 1: A method, in a data processing system, for re-issuance of credentials in a data network is provided. The method comprises receiving, from a requester entity, a first request to re-issue a target credential in a plurality of credentials of a public credential listing. Any entity, in a plurality of entities, can request re-issuance of any credential in the plurality of credentials and have the credential successfully re-issued to that entity. The method further comprises, in response to the request to re-issue the target credential, re-randomizing an original public key associated with the target credential to generate a re-randomized public key. In addition, the method comprises generating a new credential based on the target credential but with the original public key replaced with the re-randomized public key. Moreover, the method comprises providing the new credential to the requester entity. The requester entity can use the new credential for authentication transactions successfully only if the requester entity is an owner of the target credential. The above limitations advantageously enable identity security of an identity holder from collusion between credential issuers and verifiers to try to build a profile of the identity holder.

Example 2: The limitations of any of Examples 1 or 3-10, where the first request is one of a plurality of requests from the same requester entity, each request in the plurality of requests requesting re-issue of a corresponding other target credential. The above limitations advantageously provide an ability for identity holders to hide use of published credentials in authentication transactions by requesting re-issuance of a plurality of credentials in a manner where the issuer is not able to distinguish between re-issuances of credentials associated with the identity holder and re-issuances of credentials that are not associated with the identity holder.

Example 3: The limitations of any of Examples 1-2 and 4-10, where the plurality of requests comprises the first request and one or more second requests that are decoy requests submitted to hide the first request within the plurality of requests. The above limitations advantageously provide an ability for identity holders issue decoy credential re-issuance requests so that issuers and verifiers are not able to determine which re-issuance requests are from the actual identity holders associated with the certificates and those that are decoys.

Example 4: The limitations of any of Examples 1-3 and 5-10, where generating the new credential comprises performing a blind signing of the new credential by the data processing system, wherein the blind signing comprises the data processing system signing the new credential without knowing whether the requester entity is an identity owner of the target credential. The above limitations advantageously prevent the issuer of the re-issued credential from knowing whether or not the re-issued credential is being re-issued to the identity holder associated with the target credential.

Example 5: The limitations of any of Examples 1-4 and 6-10, where after blind signing of the new credential, the new credential is a reissued credential that is not able to be related to the target credential via a public key since the original public key and the re-randomized public key are uncorrelatable. The above limitations advantageously prevent issuers and verifiers from knowing which target credentials correlate with which re-issued credentials such that the issuers and verifiers cannot collude to build profiles of identity holders.

Example 6: The limitations of any of Examples 1-5 and 7-10, where the data processing system publishes all certified public keys and credentials, for all holders that have been issued a credential, in a published listing data structure accessible to all users. The above limitations advantageously allow any entity to request re-issuance of a credential in the published listing data structure so that issuers and verifiers again cannot distinguish between re-issuance requests from identity holders or from other parties that do not hold the private keys for using the re-issued credentials.

Example 7: The limitations of any of Examples 1-6 and 8-10, where the requesting entity is not the identity holder of the target credential, and wherein when the requesting entity presents the new credential to a verifier, the requesting entity provides an invalid presentation of the new credential. The above limitations advantageously allow entities that are not the identity holder for a given credential to request re-issuance of the credential but they are not able to utilize it to perform successful authentications. Thus, any entity can request a re-issuance of any certificate, such as to perform decoy requests, but only the identity holder will be able to utilize the re-issued credential to successfully perform an authentication transaction.

Example 8: The limitations of any of Examples 1-7 and 9-10, where the request is one of a plurality of requests from the requesting entity, which are submitted to the data processing system, each request in the plurality of requests is directed to a different target credential, each request is successful and generates a corresponding re-issued credential that is provided to the requesting entity, the requesting entity is an identity holder associated with the target credential, and the requesting entity uses the new credential in a presentation of the new credential as part of an interaction with a verifier and discards the other re-issued credentials. The above limitations advantageously allow identity holders to request re-issuance of a plurality of credentials to hide the re-issuance of the credential that they wish to utilize for an authentication interaction. Then, the identity holder can successfully utilize the one re-issued certificate that is of interest while discarding the decoy re-issuance requests.

Example 9: The limitations of any of Examples 1-8 and 10, where successful collusion between an issuer of credentials and a verifier to generate a profile of an identity holder is prevented by the method since the new credential is not able to be correlated, by the issuer or verifier, with the target credential via a public key. The above limitations advantageously prevent issuers and verifiers from building profiles of identity holder attributes over time from multiple correlated authentication transactions.

Example 10: The limitations of any of Examples 1-9, where the target credential is a first JavaScript Object Notation (JSON) Web Token (JWT) and wherein the new credential is a second JWT comprising a same header, same attributes, but different public key and signature than the first JWT. The above limitations advantageously transform a non-privacy preserving process of JWT authentication into a privacy-preserving process due to the inability to distinguish actual re-issuance requests from decoy issuance requests, while still allowing identity holders to utilize their valid re-issued credentials due to the proof that their re-issued credentials utilize a new public key that is a re-randomization of the original public key corresponding to the issue holder's private key.

Example 11: A system comprising one or more processors and one or more computer-readable storage media collectively storing program instructions which, when executed by the one or more processors, are configured to cause the one or more processors to perform a method according to any one of Examples 1-10. The above limitations advantageously enable a system comprising one or more processors to perform and realize the advantages described with respect to Examples 1-10.

Example 12: A computer program product comprising one or more computer readable storage media, and program instructions collectively stored on the one or more computer readable storage media, the program instructions comprising instructions configured to cause one or more processors to perform a method according to any one of Examples 1-10. The above limitations advantageously enable a computer program product having program instructions configured to cause one or more processors to perform and realize the advantages described with respect to Examples 1-10.

The present invention will be described hereafter with reference to computer technologies including SSI and JWT as example embodiments. However, it should be appreciated that the present invention is not limited to implementations with regard to only SSI and JWT. To the contrary, the illustrative embodiments may be used with any currently known or later developed technologies and computer architectures in which credential issuance is performed by one party, held by another party, and relied upon by one or more other parties, such as in the trust triangle as discussed previously.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

As noted above, the illustrative embodiments are specifically directed to improving the way in which credential issuance and reissuance is performed so as to improve the privacy preserving nature of credentialed transactions in computing systems, while providing compatibility with established standards so as to make implementation of the mechanisms of the illustrative embodiments easier to implement. In order to demonstrate the improvements of the illustrative embodiments, an example, but non-limiting, embodiment involving SSI and JWTs will be described. It will be readily apparent to those of ordinary skill in the art in view of the present description how the mechanisms of the illustrative embodiments may be adapted to other technologies and computer architectures for credential issuance and reissuance.

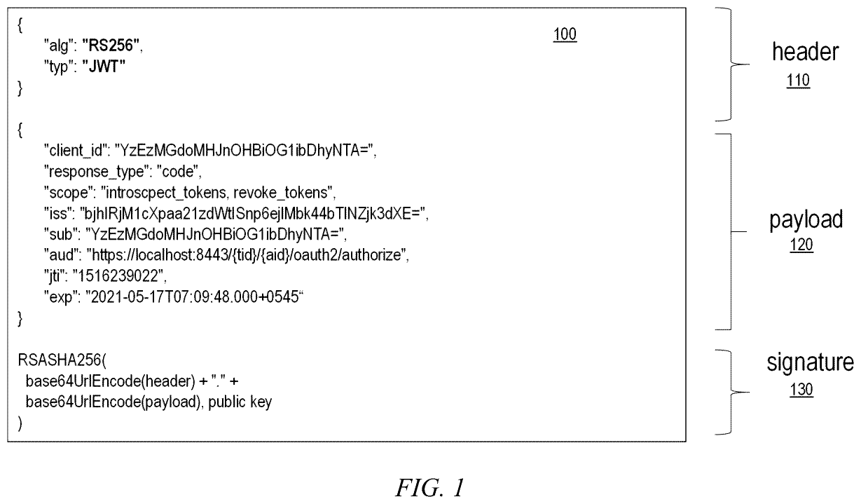

As mentioned previously, a JSON web token (JWT) is a data structure or token that is comprised of three main parts including a header, a payload, and a signature. FIG. 1 is an example of a JWT type token which may be used in one or more of the illustrative embodiments described herein. As shown in FIG. 1, the JWT token 100 includes a header 110, a payload 120, and a signature 130. The header 110 identifies which cryptographic algorithm, e.g., RS256 in the depicted example, that is used to generate the signature 130 and the type of the token 100. The payload 120 contains a set of claims and corresponding data. The signature 130 securely validates the JWT token 100. The signature is calculated by encoding the header and payload using an encoding standard and concatenating the two together. The resulting string is then run through the cryptographic algorithm specified in the header 110, which results in the signature 130. The JWT token 100 may be used to exchange credentials between parties as part of a data transaction.

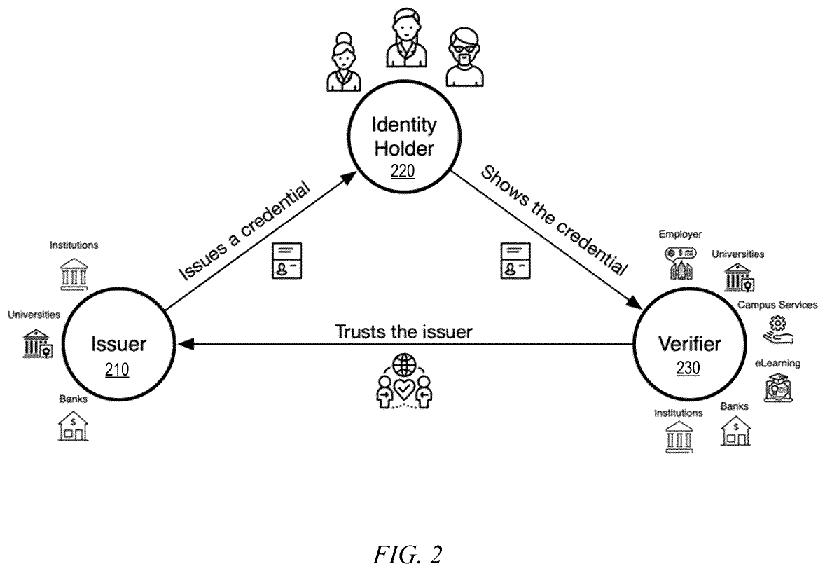

FIG. 2 is an example diagram illustrating a trust triangle relationship between issuer, holder, and verifier, in which such JWT tokens may be utilized to exchange certifications between the parties. As shown in FIG. 2, in the trust triangle arrangement, an issuer 210 issues credentials to an identity holder 220. The issuer 210 may be a government organization, financial institution, educational institution, healthcare institution, or other organization that verifies information about the identity holder 220 and issues the credentials to the identity holder to attest that the information they provided is valid. That is, the issuer 210 attests, through the issuance of credentials, that the issuer 210 trusts the identity holder 220. For example, a government organization may issue an individual a license or identification card that verifies the individual for a particular purpose, e.g., a state's department of motor vehicles issues a person a driver's license to allow them to legally operate a vehicle within the state.

The identity holder 220, or simply “holder” 220, is the owner of the credentials issued to them by the issuer 210. The holder 220 can create a verifiable presentation of the verifiable credentials issued by the issuer 210. The holder 220 may share the presentation of these verifiable credentials to other parties, referred to as the verifiers 230. The verifiers 230 utilize the verifiable credentials in the presentation from the holder 220 to verify the holder 220 or otherwise validate information shared by the holder 220.

The verifier 230 is a party that verifies a credential to make sure that it is still a valid credential, has not been tampered with, and is from an authorized holder 220. The verifier 230 operates on presentations from holders 220. The verifier 230 is a party that needs to obtain certain information about the holder 220 in order to provide some service or access to resources associated with the verifier 230 and requests proof of the information from the holder 220. This proof may be provided by the holder 220 in a presentation comprising the issued token from the issuer 210. As the verifier 230 trusts the issuer 210, the issuer 210 trusts the holder 220, and the holder 220 trusts the issuer, the verifier 230 attributes its trust in the issuer 210 to the holder 220 and the holder 220 attributes its trust in the issuer 210 to the verifier 230, thereby generating the trust triangle arrangement.

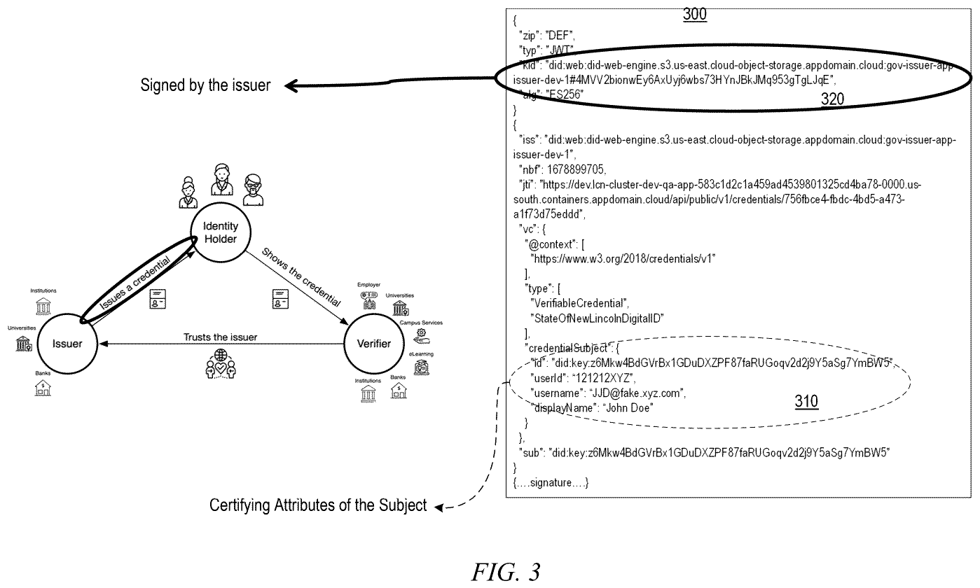

FIG. 3 is an example diagram illustrating a verifiable credential issued by an issuer in the trust triangle in accordance with JWT and Self-Sovereign Identity (SSI) protocol. As shown in FIG. 3, as part of the interaction between the issuer 210 and the identity holder 220, the issuer 210 issues a verifiable credential 300 to the identity holder 220. The verifiable credential 300 is in the form of a JWT token and thus, has a corresponding format including header, body, and signature. The body of the JWT token comprises the verifiable credential data including the attributes 310 of the credential subject which may specify personal information of the credential subject 310, e.g., user id, username, display name, and the like, as well as the public key associated with the subject, e.g., the “did:key:z6M . . . ” in the depicted example. In the header of the JWT token, the issuer 210 signs the verifiable credential 300 with an issuer signature 320. Thus, the issuer 210 is verifying that the attributes and public key 310 in the payload of the verifiable credential 300 are trusted to be valid for the subject.

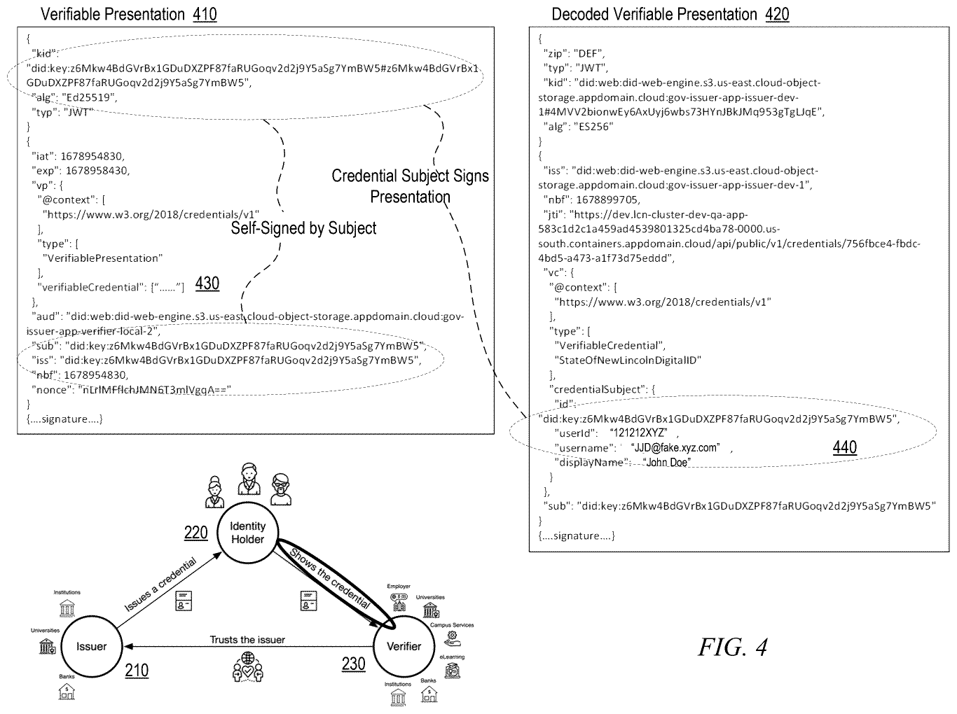

FIG. 4 is an example diagram illustrating a JWT token shown by the holder to the verifier in accordance with JWT and SSI protocol. As shown in FIG. 4, when the holder 220 presents the verifiable credential issued by the issuer 210 to the verifier 230, it is presented in a verifiable presentation 410, which is a JWT token and which may be decoded into the decoded verifiable presentation 420. The presentation of the verifiable credential includes a self-signing of the verifiable credential by the credential subject. That is, the public key of the subject is used both in the header and the payload to sign the verifiable presentation 410. The encrypted verifiable credential 430 embedded in the verifiable presentation 410 includes the attributes of the credentialed subject 440, as shown in the decoded verifiable presentation 420. The decoded verifiable presentation 420 is the same as the verifiable presentation 410, other than the verifiable credential 430 has been decoded to access the subject attributes, which includes the public key of the subject. Assuming that the presentation of the verifiable presentation 410 is by the credentialed subject, then the public key used to self-sign the verifiable presentation 410 should match the public key encrypted in the decoded verifiable presentation 420. No party other than the owner of the verifiable credential can properly sign the public key.

With FIGS. 1-4 in mind, it should be appreciated that with the SSI and JWT mechanisms shown in these figures, deanonymization of individuals is possible through correlation of authentications over time. For example, the SSI and JWT mechanisms operate on the assumption that the subject, identity holder 220, is using their public key to authenticate themselves to the verifiers via the certifications issued by the issuer 210. If the subject includes in a JWT token, uniquely identifiable attributes of the subject, e.g., name, social security number, email address, etc., then there clearly is no privacy should anyone obtain access to those attributes in the JWT token. However, even if only a limited number of attributes of the subject are disclosed in a JWT token, and those attributes are limited to only those that cannot by themselves uniquely identify an individual, correlation of authentications over time can be used to build a profile of an individual using the public key as a basis for performing the correlations. That is, if the subject uses the same public key to verify themselves with different verifiers 230, even if each authentication utilizes different subject attributes in the payload, the verifiers 230 may colluded with one another, or may individually build up over time, a profile of the individual associated with the particular public key. For example, if multiple different authentications are performed using the same public key but different “claims” or subject attributes in the payload of the tokens, these attributes may be compiled together by the verifier, or through a collusion between verifiers such that, for example, in one authentication, a vaccination status of the subject may be disclosed, in another authentication a country of origin may be disclosed, in another authentication, a gender may be disclosed, etc., such that if one is able to correlate all this information together, a profile may be generated for an individual having the individual's country, vaccination status, and gender. Over time, the information correlated becomes more and more specific to a particular individual and has the potential of identifying a specific person. This may allow bad actors to gain access to sensitive information about an individual and allow for identity theft.

Even in cases where multiple public keys are utilized by the subject, such correlation is still possible if there is collusion between the issuers 210 and the verifiers 230. That is, from a security stand point, in order to present a secure system, certain trust assumptions must be made. That is, it is assumed that verifiers want to profile users by collecting, storing, and analyzing as many attributes as possible from subjects they interact with. Similarly, it is assumed that issuers are honest and will faithfully issue credentials to users with the correct attributes, however will collude with verifiers to profile users. Thus, in accordance with the illustrative embodiments, issuers must be trusted to issue correct attributes, but otherwise, do not need to be trusted, i.e., in other schemes issuers would also need to be trusted to keep the privacy of the issued credentials, but that is not required in the illustrative embodiments since the illustrative embodiments provide mechanisms that address situations where an issue may be actively malicious.

Thus, in order to ensure the most security for subject identities in a trust triangle relationship such as that shown in FIGS. 1-4, it must be assumed that it is possible for an issuer 210 and a verifier 230 to collude for malicious or non-malicious reasons. Under these assumptions, if one were to try to circumvent the ability of parties to compile a profile of a subject from multiple authentication transactions over time by using multiple different public keys, it is still possible through collusion for the issuer and verifier to generate the profile of the individual. That is, if a user has 10 different public keys and uses them for different verifiers 230, randomly selects a public key, or otherwise attempts to keep issuers and verifiers from compiling profiles of a subject, the issuer still knows the public keys (even if there are multiple ones) that are issued to a subject and, with collusion with the verifiers 230, is able to gain access to the attributes that the identity holder 220 shares with the verifiers. Over time, multiple partial profiles associated with the different public keys may be compiled and, through collusion with the issuer, may be combined together to generate a more thorough profile of the subject.

The ability to compile profiles of subjects through collusion of issuers and verifiers is still present even if a subject uses a public key once and then discards it and obtains a new public key from the issuer 210 for repeatedly for each subsequent authentication transaction. Again, the issuer 210 is still aware of each of the public keys associated with a particular subject each time the issuer 210 issues a new certification. Thus, the issuer 210 is still able to build the profile of the subject and is able to collude with the verifier 230 to obtain attributes of the subject from the presentations made by the holder 220 to the verifier 230 using the issued certification associated with the public keys. Thus, SSI with token based authentication still has issues with privacy of individual's identity and attributes even when these various measures are implemented to attempt to address it. Each potential solution only makes the building of the profile of the subject more difficult, but does not make it impossible, especially when collusion between issuers and verifiers is present.

The illustrative embodiments provide an improved computing tool and improved computing tool operations/functionality that is specifically directed to solving the problems in data network party trust architectures, such as the trust triangle configuration described above with regard to FIGS. 1-4, by providing computer mechanisms that implement a new credential issuance and re-issuance computer functionality that prevents subject profile compilation even in the presence of collusion between trusted parties. The illustrative embodiments provide an enhanced privacy of subject identities and corresponding data while providing compatibility with standardized cryptographic mechanisms. With the mechanisms of the illustrative embodiments, while issuance and re-issuance is modified in accordance with the present invention, the presentation of credentials by the identity holder and the verification of the credentials by the verifiers are kept identical and fully compatible with standards, such as JWT/OpenID standards, or the like.

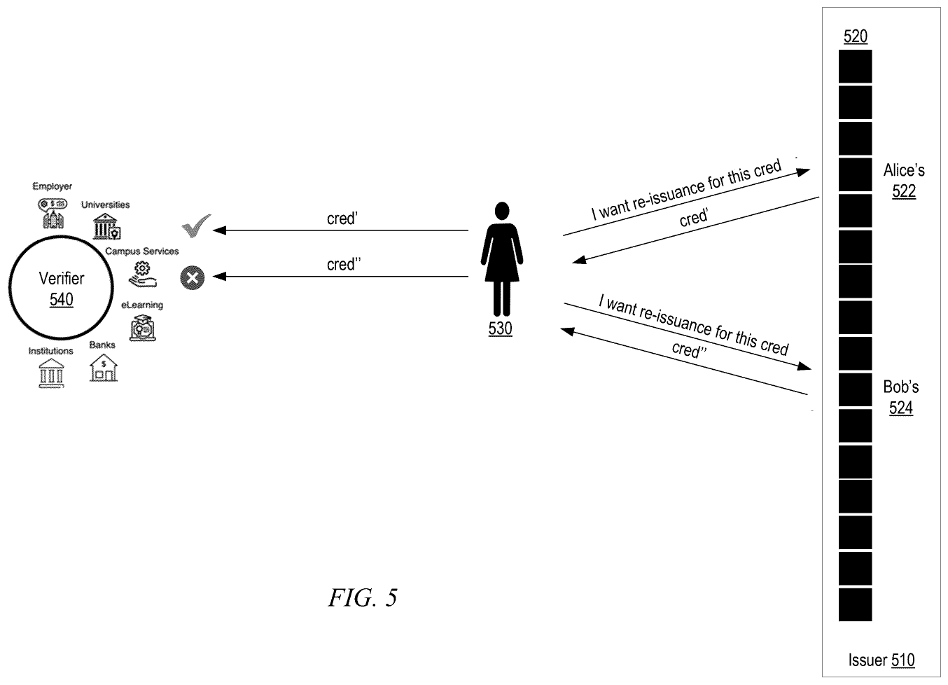

FIG. 5 is an example diagram illustrating the interaction between the issuer, a user, and a verifier in accordance with the issuance and reissuance mechanisms of the illustrative embodiments. With the mechanisms of the illustrative embodiments, the issuance of credentials by the issuer 510 is split into two primary operations, i.e., initial issuance and re-issuance. Initial issuance takes place with a set of attributes and a public key being certified (signed) in a credential by an issuer 510. During initial issuance, the subject, e.g., user 530, reveals themselves to the issuer 510 to obtain credentials, where the revelation involves only the attributes needed for the issuer 510 to issue credentials to the subject, e.g., user 530. Cryptographic mechanisms are implemented to encrypt the subject's private information in order to generate and provide the subject with the requested credential, however the issued credential is not itself directly used in authentication transactions with verifiers. The issuance is to obtain the original public key for the subject, e.g., user 530, which corresponds to the subject's private key in a private-public key type encryption. Thus, there is an established context between the issuer 510 and the subject 530 such that the issuer 510 knows some attributes of the subject 530 and one of the subject's public keys, which corresponds to the identity holder's private key which is only known to the identity holder, e.g., the subject 530.

The issuer 510 publishes all certified public keys and credentials in a published listing data structure 520 for all users that have been issued a credential by the issuer 510. It should be appreciated that, in public-key cryptography, public keys are used for generating signatures and private keys sign the credentials. A credential is made of a set of attributes and a signature from the issuer, verifiable with the issuer public key, where the attributes also include a public key of the holder. A presentation contains the credential together with a signature form the holder, verifiable with the public key that the credential certifies.

With the mechanisms of the illustrative embodiments, anyone can ask for re-issuance of any credential and such re-issuance always succeeds. This may be the actual identity holder or subject of the actual credential or it may be any other entity, such that it is not known whether the request for re-issuance is coming from the actual identity holder (subject) 530 or from some other entity. In allowing any entity to request re-issuance of a credential, and ensuring that such re-issuance requests always succeed, an issuer 510 and a verifier 540 can never know whether the attributes submitted to a verifier 540 with a re-issued credential corresponds to the particular subject or not, and correlations between different authentication transaction attributes cannot be made as it is not clear which reissuances are from the actual identity holder of that particular re-issued credential.

During re-issuance, the entity is essentially asking for a different public key, i.e., a re-rerandomized public key, for encrypting the same attributes as were disclosed to the issuer 510 during the initial issuance and encrypted using the previously published public key. A credential in the listing 520 is a signed data structure comprising the combination of the encrypted attributes with the public key in the payload. The party requesting re-issuance will be provided with the re-issued credential, with the re-randomized public key and the same attributes, however if they are not the identity holder associated with the original credential issued by the issuer 510 during the initial issuance, any subsequent authentication using the re-issued credential will fail as only the original holder of the private key associated with the public key will be able to authenticate. That is, presentation of the credential requires the holder to create a signature which is verifiable with the public key that is certified. The public key certified in a re-issued credential is a re-randomization of the public key that was requested. As such, for cryptographic reasons, only someone who knew the private key of the original public key also knows the private key of the re-randomized public key and generates a verifiable signature in the presentation.

Hence, upon re-issuance, any identity holder 530 in the overall system can ask for the re-issuance of any credential in the public listing data structure 520, whether their own or those associated with other holders. Thus, for example, as shown in FIG. 5, a user, Alice, can send a request to the issuer 510 that requests Alice's credential (cred) 522, to be reissued. The request for reissuance always successfully occurs and thus, Alice is presented with the reissued credential, generated using a re-randomized public key, which is referred to herein as cred′. Alice may then present the reissued credential cred′ to a verifier 540 for authentication. As this is Alice's own credential that has been reissued, Alice has access to Alice's private key and thus, can authenticate with the verifier 540.

Now, assume that Alice requests reissuance of Bob's credential 524 in the listing 520. As with her own credential 522, the request for reissuance of Bob's credential also occurs successfully in the issuer 510 and a reissued credential, referred to as cred″, is presented to Alice. However, Alice is not Bob and thus, if Alice attempts to use the credential cred″ to authenticate with a verifier 540, Alice is not able to authenticate with the verifier 540 successfully as Alice does not have access to Bob's private key.

Reissuance is a public, unauthenticated service. This allows a user to request reissuance of a large number of credentials, or even all of the credentials, in the listing data structure 520 before conducting a transaction with a re-issued credential. Hence, from the issuer 510 stand point, the issuer has issued a large number of valid credentials but does not know which reissuance was from the authenticated identity holder of the credential, e.g., if Alice requests the reissuance of all of the credentials in the listing 520, the issuer 510 does not know if the reissuance is being performed by Alice, Bob, or some other holder of a credential in the listing 520. Thus, if the verifier 540 attempts to collude with the issuer 510 to obtain information about a subject, the issuer 510 will not be able to determine which reissued credential corresponds to that subject. This is essentially a decoy reissuance request that can be used to prevent profiling of subjects, i.e., the issuer 510 cannot distinguish decoy reissuance requests from valid ones.

Thus, a significant feature of the mechanisms of the illustrative embodiments is that the illustrative embodiments provide logic in the issuer 510 that performs both issuance of credentials initially, to establish a context between an identity holder and a public key, and reissuance of credentials in a manner that prevents collusion and correlation of authentication transactions being able to successfully build a profile of an identity holder. As noted above, this logic ensures that reissuance of credentials is always successful and equips the requester with a signature over the same set of certified attributes for the chosen credential that is reissued, and for a re-randomization of the associated public key. However, only the authorized identity holder of the credential can actually make use of the obtained re-issued credential because only the authorized identity holder has access to the private key. In private-key/public-key encryption, anyone can use the publicly available key, but only the identity holder having the private key is able to properly present a signature that is verifiable with the public key. That is, Alice may request reissuance of the credentials for Bob, but Alice cannot use the reissued credentials because she does not have access to Bob's private key.

The mechanisms of the illustrative embodiments view each of the verifiable credentials in the listing 520 to have a same structure including a prologue, public key (PK), and epilogue, i.e., the message, or credential, is m={prologue, PK, epilogue}, where the prologue includes certifiable attributes that do not uniquely identify the user. The prologue and epilogue are considered to be consistent between the issuance and subsequent reissuances of the credential. The only portion of the verifiable credential that is modified between issuances and/or re-issuances of the credential is the public key. The issuer 510 blindly signs the message m and ensures that in reissuing the message, or credential, the new public key (PK′) is a rerandomization of the original public key, which is associated with the identity holder's private key. By “blindly” signing, what is meant is that the issuer 510 does not know what it is signing. Thus, in the illustrative embodiments, the public key (PK) of the original credential is re-randomized to generate a rerandomized public key (PK′) and then PK′ replaces PK in the message, i.e., m′={prologue, PK′, epilogue}. The issuer 510 then blindly signs the new message m′, which is the reissued credential cred′ or cred″ in FIG. 5.

After the successful blind signing and reissuance of the credential, the new credential, e.g., cred′ or m′, is unrelated to the old credential, e.g., cred or m. That is, to parties that do not know the original private key, the original public key and the re-randomized public key are uncorrelatable. On the contrary, to someone who knows the original private key, the re-randomized public key is just the original public key to the power of a secret value, for example. The identity holder proves in zero knowledge (zero knowledge proof) that the value of m′ that the issuer signs is the hash (such as in the case of ECDSA which prescribes hashing) of a message that contains the original attributes, and a public key which is a re-randomization of the original public key. Thus, the new credential can be used only by the identity holder of the original credential. The new credential certifies the same attributes as the old credential. The issuer 510 cannot infer anything from the new public key of the new credential. The issue also cannot distinguish between decoy reissue requests and real reissue requests from the actual identity holder.

Thus, providing a decoy request capability, as well as allowing any entity to request reissuance of a credential, the illustrative embodiments permit identity holders to essentially “hide” within the multitude of reissuance requests, e.g., hiding the actual identity holder associated with the public key in plain sight within the larger population since anyone in the population can successfully request re-issuance, not just the valid identity holder. This makes it difficult to correlate usage of public keys so as to build profiles of individuals within the larger population. With the reissuance utilizing a blind signing protocol, in the cryptographic sense, the issuer only knows which original credential (and associated public key) is the basis of the re-issuance. The issuer does not know the new, re-randomized public key that will be associated with the re-issued credential and does not know whether the valid identity holder (or owner), or someone else, requested the reissuance of the credential. Thus, the illustrative embodiments provide an improved computing tool and improved computing tool operations/functionality specifically directed to solving the problems of data security and privacy of individuals with regard to authentication token based authentication mechanisms in data networks.

From the above, it can be appreciated that the present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides credential issuance and reissuance mechanisms that improve the data security of computing systems. The improved computing tool implements mechanism and functionality, such as the credential issuance and reissuance (CIRI) computing tool, which cannot be practically performed by human beings either outside of, or with the assistance of, a technical environment, such as a mental process or the like. The improved computing tool provides a practical application of the methodology at least in that the improved computing tool is able to perform issuance of credentials and reissuance of credentials in accordance with an improved credential protocol that provides increased data security in a trust triangle between issuer, holder, and verifier of credentials.

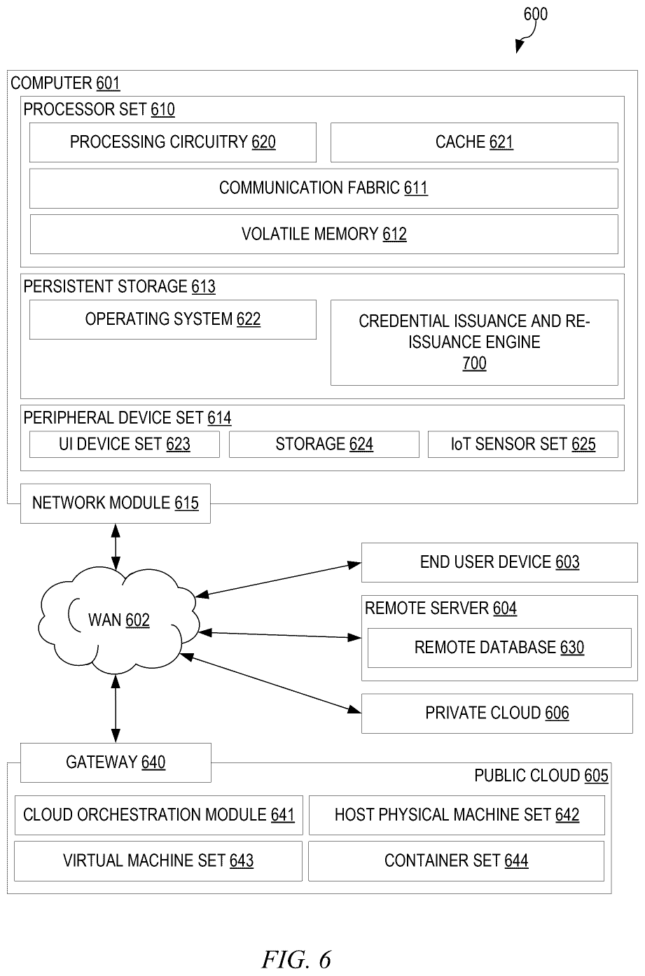

FIG. 6 is an example diagram of a distributed data processing system environment in which aspects of the illustrative embodiments may be implemented and at least some of the computer code involved in performing the inventive methods may be executed. That is, computing environment 600 contains an example of an environment for the execution of at least some of the computer code involved in performing the inventive methods, such as credential issuance and reissuance (CIRI) computing engine 700. In addition to the CIRI engine 700, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and CIRI engine 700, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in CIRI engine 700 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in CIRI engine 700 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As shown in FIG. 6, one or more of the computing devices, e.g., computer 601 or remote server 604, may be specifically configured to implement a CIRI engine 700. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 601 or remote server 604, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates issuance and reissuance of credentials in a manner that reduces or eliminates correlation of authentication transactions for generating profiles of subjects as well as reduces or eliminates the ability for collusion between issuers and verifiers to successfully result in profiling of subjects.

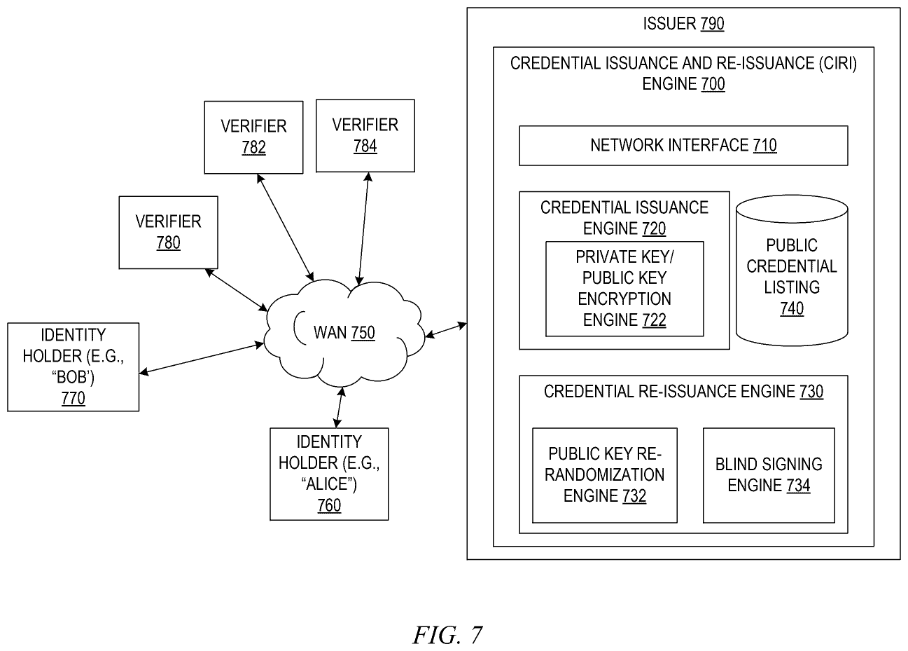

FIG. 7 is an example block diagram illustrating the primary operational components of a credential issuance and reissuance (CIRI) engine in accordance with one illustrative embodiment. The operational components shown in FIG. 7 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., requests for issuance/reissuance of credentials, and the resulting output may aid human beings, e.g., issuance/reissuance of credentials for use with authentication transactions with verifiers. The invention is specifically directed to the automatically operating computer components directed to improving the way that issuance and reissuance of credentials is performed for computer based authentication of parties involved in a trust based computer architecture, which cannot be practically performed by human beings as a mental process and is not directed to organizing any human activity.

As shown in FIG. 7, the CIRI engine 700 includes a network interface 710, a credential issuance engine 720, a credential reissuance engine 730, and a public credential listing data structure 740. The credential issuance engine 720 comprises a private key/public key encryption engine 722 that operates along with other logic of the credential issuance engine 720 to perform an initial issuance of credentials to an identity holder, such as identity holders 760 and 770, which may be computing devices with which the issuer 790 and the CIRI engine 700 perform data communications via the network interface 710 and wide area network 750.

The credential reissuance engine 730 comprises a public key re-randomization engine 732 and blind signing engine 734. The public key re-randomization engine 732 provides logic for re-randomizing public keys in issued credentials to generate re-issued credentials. The blind signing engine 734 implements a blind signing operation to sign the re-issued credentials without knowing the content of the re-issued credential with the understanding that the public key re-randomization engine 732 ensures that the new public keys generated are a re-randomization of the previous public key associated with the attributes encoded in the credential.

The public credential listing 740 stores credentials issued and/or re-issued by the issuer 790. The credentials, as noted above, have a structure including header, payload, and signature, where the credentials are considered by the credential re-issuance engine 730 to have a consistent structure of prologue, public key, and epilogue, where the only part of the structure that changes between issued credential and re-issued credential is the public key.

As shown in FIG. 7 and described previously, the CIRI engine 700 splits the issuance of credentials into initial issuance by the credential issuance engine 720 and re-issuance by the credential re-issuance engine 730. Initial issuance takes place by the credential issuance engine 720 with a set of attributes and a public key generated by the private key/public key encryption engine 722, and being certified (signed) in a credential by an issuer 790. The issuer 790 publishes all certified public keys and credentials to the public credential listing 740.

The issuer 790 can receive requests for re-issuance of any credential in the public credential listing 740 by any identity holder 760, 770, etc. or any other party. Thus, the re-issuance request may target a credential in the public credential listing 740 that is owned by the originator of the re-issuance request, or may be owned by someone other than the originator of the re-issuance request. Moreover, the re-issuance request may target more than one credential in the public credential listing 740, such as in the case of a decoy re-issuance requests, for example. This may be used to disguise an actual re-issuance request for an owner's own credentials so as to make it difficult to correlate attributes across authentication transactions.

In response to receiving a request for re-issuance, the credential re-issuance engine 730 invokes the public key re-randomization engine 732 to generate a new public key for the credential and then blindly signs the credential with the re-randomized public key via the blind signing engine 734. The modified credential is then issued to thereby re-issue the previous credential, which is always successful and equips the requester with a signature over the same set of certified attributes for the chosen credential that is reissued. The re-issued credential may be published to the public credential listing 740, replacing the previous credential that was the subject of the re-issuance.

Thus, for example, an identity holder, Alice, via her computing device 760 may be provided with an initial credential generated by the credential issuance engine 720, and which is then published in the public credential listing 740. Similarly, another identity holder, Bob, may via his computing device 770 also obtain an issued credential which is included in the public credential listing 740. Alice may then request, from the issuer 790, a re-issuance of one or more credentials, such as both Alice and Bob's credentials in the public credential listing 740. The credential re-issuance engine 730 performs re-issuance of the credentials, however, only the valid identity holder of the credential can actually make use of the obtained re-issued credential. That is, Alice can only use Alice's reissued credential and will not be able to use Bob's reissued credential.

Thus, if Alice wishes to authenticate with one of the verifiers 780-784, Alice can provide a presentation via the computing device 760 to the verifier 780, for example, which includes the re-issued credential and one or more attributes required for the authentication. If the re-issued credential is owned by Alice, then the authentication will succeed. However, if Alice does not own the re-issued credential, e.g., the re-issued credential is Bob's re-issued credential, then the authentication will not succeed.

Whether the re-issuance of Bob's credential is to Bob or to Alice is not known to the issuer 790 as the issuer only sees that two credentials were validly re-issued and does not know which re-issuance was performed by the valid identity holder or some other party. That is, the issuer 790 performs the re-issuance blindly and this re-issuance always succeeds regardless of which party requests the re-issuance. This allows for decoy reissuance requests that effectively hide the actual re-issuance of credentials such that an issuer and verifier cannot collude to profile an identity holder.

It should be appreciated that the illustrative embodiments utilize a public listing of issued credentials maintained by the issuer. Each entry in the list contains a public key and a set of attributes. The reissuance protocol of the illustrative embodiments may then create a new credential for the same set of attributes and a re-randomization of the public key. However, in other illustrative embodiments, instead of a single set of attributes, multiple sets of attributes may be attached to the public key. For example, a first set of attributes may comprise {first name, last name, DoB}, while a second set of attributes may comprise {first name, last name, vaccination status}, etc. At re-issuance time, the requester can specify one of the sets of attributes and get a re-issued credential for that specific set of attributes. Moreover, in some illustrative embodiments, instead of the attributes, either a single set of attributes or multiple sets of attributes, may be presented as a hash of the attributes attached to the public key rather than presenting the attributes “in the clear”.

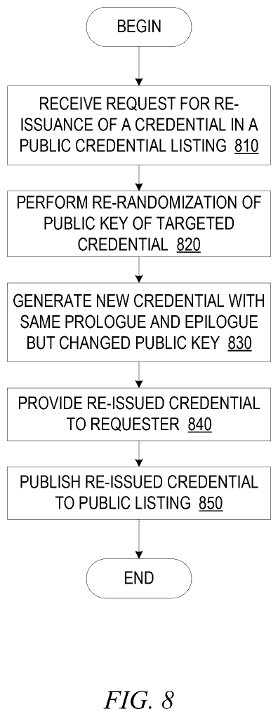

FIG. 8 presents a flowchart outlining example operations of elements of the present invention with regard to one or more illustrative embodiments. It should be appreciated that the operations outlined in FIG. 8 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 8, and may, in some cases, make use of the results generated as a consequence of the operations set forth in FIG. 8, the operations in FIG. 8 themselves are specifically performed by the improved computing tool in an automated manner.

FIG. 8 is a flowchart outlining an example operation for re-issuing credentials in accordance with one illustrative embodiment. As shown in FIG. 8, the operation starts by receiving a request for re-issuance of a credential in a public credential listing (step 810). A re-randomization of the public key in the targeted credential is generated (step 820) and a new credential with the same prologue and epilogue is generated with the re-randomized public key (step 830). The new credential is blindly signed by the issuer and the new, re-issued, credential is provided to the requester (step 840). The new, re-issued, credential is added to the public credential listing (step 850), and the operation terminates. It should be appreciated that the present invention takes a process of issuing credentials, such as the issuance of JWT credentials, which is a non-privacy preserving process, and transforms the process into a privacy-preserving process through the specific issuance and re-issuance mechanisms of the illustrative embodiments.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for re-issuance of credentials in a data network, the method comprising:
receiving, from a requester entity, a first request to re-issue a target credential in a plurality of credentials of a public credential listing, wherein any entity, in a plurality of entities, can request re-issuance of any credential in the plurality of credentials and have the credential successfully re-issued to that entity;
in response to the request to re-issue the target credential, re-randomizing an original public key associated with the target credential to generate a re-randomized public key;
generating a new credential based on the target credential but with the original public key replaced with the re-randomized public key; and
providing the new credential to the requester entity, wherein the requester entity can use the new credential for authentication transactions successfully only if the requester entity is an owner of the target credential.

2. The method of claim 1, wherein the first request is one of a plurality of requests from the same requester entity, each request in the plurality of requests requesting re-issue of a corresponding other target credential.

3. The method of claim 2, wherein the plurality of requests comprises the first request and one or more second requests that are decoy requests submitted to hide the first request within the plurality of requests.

4. The method of claim 1, wherein generating the new credential comprises performing a blind signing of the new credential by the data processing system, wherein the blind signing comprises the data processing system signing the new credential without knowing whether the requester entity is an identity owner of the target credential.

5. The method of claim 4, wherein after blind signing of the new credential, the new credential is a reissued credential that is not able to be related to the target credential via a public key since the original public key and the re-randomized public key are uncorrelatable.

6. The method of claim 1, wherein the data processing system publishes all certified public keys and credentials, for all holders that have been issued a credential, in a published listing data structure accessible to all users.

7. The method of claim 1, wherein the requesting entity is not the identity holder of the target credential, and wherein when the requesting entity presents the new credential to a verifier, the requesting entity provides an invalid presentation of the new credential.

8. The method of claim 1, wherein:
the request is one of a plurality of requests from the requesting entity, which are submitted to the data processing system,
each request in the plurality of requests is directed to a different target credential,
each request is successful and generates a corresponding re-issued credential that is provided to the requesting entity,
the requesting entity is an identity holder associated with the target credential, and
the requesting entity uses the new credential in a presentation of the new credential as part of an interaction with a verifier and discards the other re-issued credentials.

9. The method of claim 1, wherein successful collusion between an issuer of credentials and a verifier to generate a profile of an identity holder is prevented by the method since the new credential is not able to be correlated, by the issuer or verifier, with the target credential.

10. The method of claim 1, wherein the target credential is a first JavaScript Object Notation (JSON) Web Token (JWT) and wherein the new credential is a second JWT comprising a same header, same attributes, but different public key and signature than the first JWT.

11. A computer program product comprising a computer readable storage medium having a computer readable program stored therein, wherein the computer readable program, when executed in a data processing system, causes the data processing system to:
receive, from a requester entity, a first request to re-issue a target credential in a plurality of credentials of a public credential listing, wherein any entity, in a plurality of entities, can request re-issuance of any credential in the plurality of credentials and have the credential successfully re-issued to that entity;
re-randomize, in response to the request to re-issue the target credential, an original public key associated with the target credential to generate a re-randomized public key;
generate a new credential based on the target credential but with the original public key replaced with the re-randomized public key; and
provide the new credential to the requester entity, wherein the requester entity can use the new credential for authentication transactions successfully only if the requester entity is an owner of the target credential.

12. The computer program product of claim 11, wherein the first request is one of a plurality of requests from the same requester entity, each request in the plurality of requests requesting re-issue of a corresponding other target credential.

13. The computer program product of claim 12, wherein the plurality of requests comprises the first request and one or more second requests that are decoy requests submitted to hide the first request within the plurality of requests.

14. The computer program product of claim 11, wherein generating the new credential comprises performing a blind signing of the new credential by the data processing system, wherein the blind signing comprises the data processing system signing the new credential without knowing whether the requester entity is an identity owner of the target credential.

15. The computer program product of claim 14, wherein after blind signing of the new credential, the new credential is a reissued credential that is not able to be related to the target credential via a public key since the original public key and the re-randomized public key are uncorrelatable.

16. The computer program product of claim 11, wherein the data processing system publishes all certified public keys and credentials, for all holders that have been issued a credential, in a published listing data structure accessible to all users.

17. The computer program product of claim 11, wherein the requesting entity is not the identity holder of the target credential, and wherein when the requesting entity presents the new credential to a verifier, the requesting entity provides an invalid presentation of the new credential.

18. The computer program product of claim 11, wherein:
the request is one of a plurality of requests from the requesting entity, which are submitted to the data processing system,
each request in the plurality of requests is directed to a different target credential,
each request is successful and generates a corresponding re-issued credential that is provided to the requesting entity,
the requesting entity is an identity holder associated with the target credential, and
the requesting entity uses the new credential in a presentation of the new credential as part of an interaction with a verifier and discards the other re-issued credentials.

19. The computer program product of claim 11, wherein successful collusion between an issuer of credentials and a verifier to generate a profile of an identity holder is prevented by the method since the new credential is not able to be correlated, by the issuer or verifier, with the target credential via a public key.

20. An apparatus comprising:
at least one processor; and
at least one memory coupled to the at least one processor, wherein the at least one memory comprises instructions which, when executed by the at least one processor, cause the at least one processor to:
receive, from a requester entity, a first request to re-issue a target credential in a plurality of credentials of a public credential listing, wherein any entity, in a plurality of entities, can request re-issuance of any credential in the plurality of credentials and have the credential successfully re-issued to that entity;
re-randomize, in response to the request to re-issue the target credential, an original public key associated with the target credential to generate a re-randomized public key;
generate a new credential based on the target credential but with the original public key replaced with the re-randomized public key; and
provide the new credential to the requester entity, wherein the requester entity can use the new credential for authentication transactions successfully only if the requester entity is an owner of the target credential.
